(19) United States
(12) Patent Application Publication
(10) Pub. No.: US 2009/0205475 A1
(43) Pub. Date: Aug. 20, 2009

(54) DEVICE FOR PUNCHING BLANKS OUT OF A FLAT SHEET

(75) Inventor: Franz Vossen, Stockach-Wahlwies (DE)

Correspondence Address: BACHMAN & LAPOINTE, P.C., 900 CHAPEL STREET, SUITE 1201, NEW HAVEN, CT, 06510, US

(73) Assignee: Franz Vossen, Stockach-Wahlwies (DE)

(21) Appl. No.: 12/389,505

(22) Filed: Feb. 20, 2009

(30) Foreign Application Priority Data
Feb. 20, 2008 (DE) 20 2008 002 390.4
Nov. 17, 2008 (DE) 20 2008 015 220.8

(51) Int. Cl. B26D 7/02

(52) U.S. Cl. 83/452

(57) ABSTRACT

Device for punching blanks from a planar part (10), having a punching blade (20) attached in a support plate (22) and projecting from the latter as a blade or cutting line, and profile strips which flank the punching blade (20), are made of a material that is flexible to a limited extent and are each inserted into a channel profile (50) in a positive-locking manner with a region of their cross section, wherein both the channel profile (50) and the profile strip, as insert profile (70), are formed from a material that is elastic to a limited extent.

### BACKGROUND OF THE INVENTION

The invention relates to a device for punching blanks from a planar part, in particular package blanks of cardboard or corrugated board, having a punching blade, attached in a support plate and projecting from the latter as a blade or cutting line, and profile strips which flank said punching blade, are made of a material that is flexible to a limited extent and are each inserted into a channel profile in a positive-locking manner with a region of their cross section.

A device of this type can be seen from EP 1 567 309 B1. A strip steel blade is accompanied by lateral profile strips made of rubber or flexible plastic. The channel profiles made of a rigid material are adhesively bonded in a planar manner to the support plate made of plywood.

Owing to this device, package blanks can be cut out in groups from a cardboard or corrugated board sheet. The automatic punching machine processes the “printed sheets” cyclically; the cutting contours and scoring lines are mainly produced in its punching section.

To transport the punched sheet further, “holding points” are required which hold the packages—also called copies—together. When the cutting lines penetrate into the sheet material, very high wedge forces develop, which attempt to destroy the holding points. By the attachment of the abovementioned channel profiles running on both sides of the punching blade, together with the elastic profile strips clipped in place, the elastic pressure emanating from said profile strips produces a high frictional resistance between the underside of the punched sheet and the surface, and said frictional resistance prevents the holding points from rupturing. The cross section of the elastic profile strip is in this case to be selected in such a way that forces additionally act toward the blade.

### SUMMARY OF THE INVENTION

In the knowledge of these conditions, the aim of the inventor is to simplify the device, facilitate the manipulation of the machine parts and improve production.

The teaching of the present disclosure leads to the achievement of this object as well as additional favorable developments. In addition, all the combinations of at least two of the features disclosed herein come within the scope of the invention. When designation ranges are specified, values lying within said limits are also intended to be disclosed, and to be capable of being used in any desired manner, as limit values.

According to the invention, both the channel profile and the profile strip, as insert profile, are formed from a material that is elastic to a limited extent; both the channel profile and the insert profile are preferably made of the material that is elastic to a limited extent, with a molded strip connecting the two. Said material may be an elastomer, a caoutchouc or preferably a rubber material of 60 Shore to 90 Shore.

According to the invention, one channel leg of the channel profile is to have an inner rib which projects toward its channel space and from which an inner contour, in the shape of a circle segment in cross section, of the channel space starts, that is to say an undercut lateral region of the latter. Apart from that, an inner rib of the other channel leg—likewise as a retaining member for the insert profile—is opposite this inner rib of the channel leg; these inner ribs jointly define an undercut region of the channel space in the channel profile.

The side faces of the insert profile preferably run at an angle to the center line of the cross section and are provided at one end with a respective side rib.

It is also important that the base surface, assigned to the two side ribs, of the insert profile is to be assigned to the inner surface of the channel profile, with the molded strip being bent. In addition, it has proved to be favorable to arrange the two side ribs of the insert profile at a distance from the inner contour of the channel profile fitted into said insert profile.

It has also proved to be favorable to form the unit comprising the channel profile, the molded strip and the insert profile from said molding material by extrusion, that is to say in a single molding operation.

It is also within the scope of the invention that the molded strip of small thickness is integrally formed with its marginal regions on opposite side faces of the channel profile on the one hand and of the insert profile on the other hand. In addition, that side face of a channel leg of the channel profile which faces the molded strip has two inclined surfaces which run at an angle—preferably about 130° to 140°—to one another and which form a type of projecting construction line between them. The molded strip connecting the channel profile and the insert profile is preferably integrally formed on the inclined surface close to the free end of the channel leg. The molded strip is preferably integrally formed on that side face of the insert profile which is adjacent to the channel profile; the side faces are to run at a slight angle to the center line of the insert profile cross section and are provided at one end with a respective side rib.

### BRIEF DESCRIPTION OF THE DRAWINGS

Further advantages, features and details of the invention follow from the description below of preferred exemplary embodiments and with reference to the drawing, in which:

FIG. 1 shows a plan view of a punching die of an automatic punching machine with folding box blanks resting thereon;

FIGS. 2, 4 show details of a punching operation, on an enlarged scale compared with FIG. 1, in the cross section of a tool which contains, according to the prior art, two rubber strips engaging in channel profiles;

FIG. 3 shows part of a blade in an oblique view;

FIGS. 5 to 6 show a front view of a tool according to the invention in the dismantled state and assembled state, respectively.

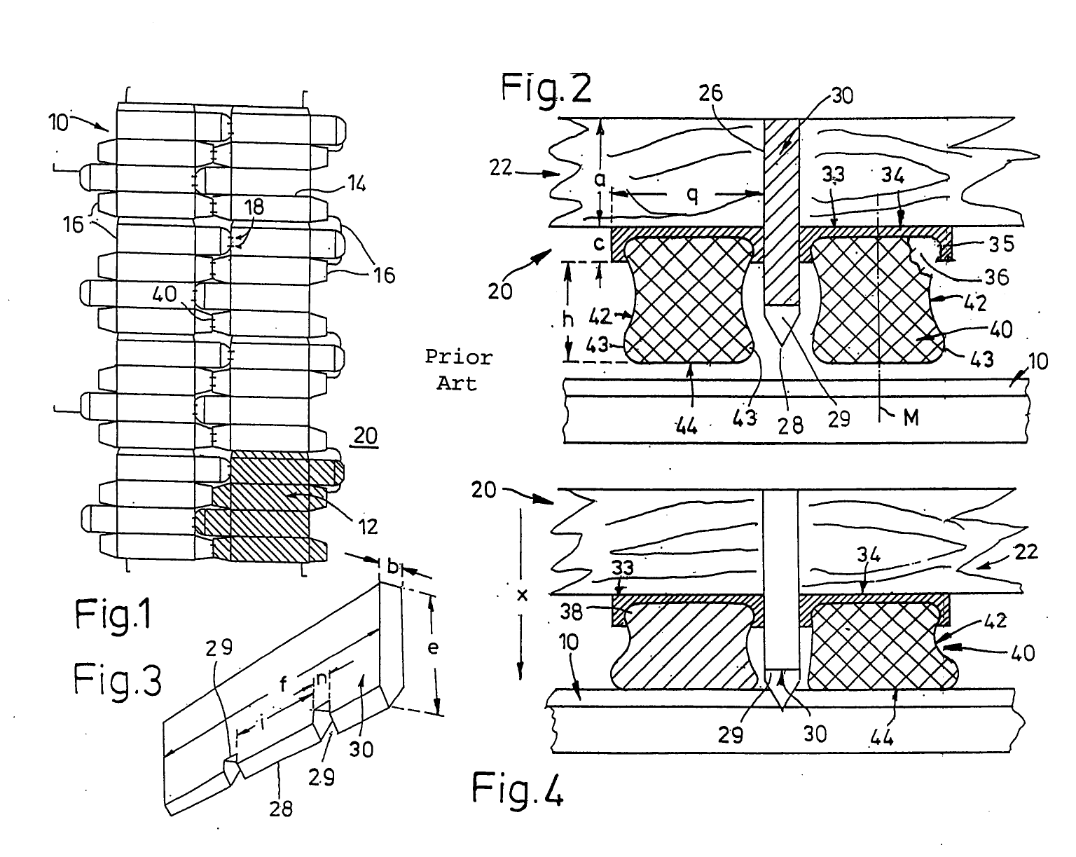

### DETAILED DESCRIPTION

For punching packages from cardboard or corrugated board, a sheet 10 made of this material is fed, for example, to a flat bed automatic punching machine; the sheet 10 exhibits the contours of eight adjoining blanks 12 for folding boxes; these blanks 12 result in cyclic punching operations and have scoring lines 14—predetermining the subsequent folding operation—and cutting lines 16, defining the outside, as punching contours; adjacent cutting lines 16 are connected by pairs of “holding points” 18; the latter are required for transporting the punched sheet 10 further to a punching tool 20.

During its processing, the cardboard or corrugated board sheet 10 rests below a support plate 22, of thickness a, of the punching tool 20 according to FIG. 2 of a punching plate 24. The support plate 22 consists of a multi-layer plywood plate in which laser cuts 26 have been made, in an arrangement corresponding to the contours of the intended packages, for accommodating punching blades as “blade or cutting lines” 30; a plurality of packages—up to fifty or sixty—are often arranged in groups on such a cardboard or corrugated board sheet 10.

As FIG. 3 shows, the punching blade 30, which as stated is designated as blade or cutting line and which has, for example, a thickness b of 0.7 mm, a height e of 24 mm here and a length f of about 60 mm, is provided at its cutting edge 28 with notches or interruptions 29 which are arranged at a distance i from one another, have a length n of, for example, 1 mm and determine said holding points 18 in a cutting line 16 produced in the sheet 10.

That section of the punching blade 30 which projects from the plywood plate 22 is flanked on both sides by channel profiles 34 formed from metal, in particular light metal, plastic or ceramic and having a height c of about 2 mm. The width q of the channel profiles 34 measures about 12 mm here. The channel legs 35 of the channel profile 34, adhesively bonded to the plywood plate 22 by an adhesive layer 33, define a channel space 36 and are curved on the inside in cross section in FIGS. 2, 4—with a respective lateral undercut region being formed—in order to provide a clamping hold for the ridge region 38, correspondingly formed in cross section, of a rubber profile 40 of virtually rectangular cross section of free height h. The profile side faces 42, in cross section, are curved slightly away from the ridge region 38 toward the profile center line M and are curved further downwards and outwards, such that a type of foot bead 43 is produced on both sides close to the profile base surface 44.

During the punching operation, the base surfaces 44, directed in pressure direction x, of the rubber profiles 40 come to rest on the sheet 10 on both sides of the corresponding punching contour 16—with the profile cross section being changed (FIG. 4). Huge wedge forces which destroy the holding points 18 are produced when the cutting lines 30 penetrate into the sheet material. Due to the insertion of the rubber profiles 40 on both sides of the punching blade 30, the pressure of said rubber profiles 40 produces a high frictional resistance between the underside of the sheet 10 and the surface of the punching board 24, said frictional resistance preventing the holding points 18 from rupturing. In this case, the cross section of the rubber profiles 40 is selected in such a way that additional forces act toward the punching blade 30.

The rubber profiles 40 sitting in the channel profiles 34 adhesively bonded in place can be easily removed from and returned to said channel profiles 34. A quick change to other, i.e. softer, rubber materials is also possible.

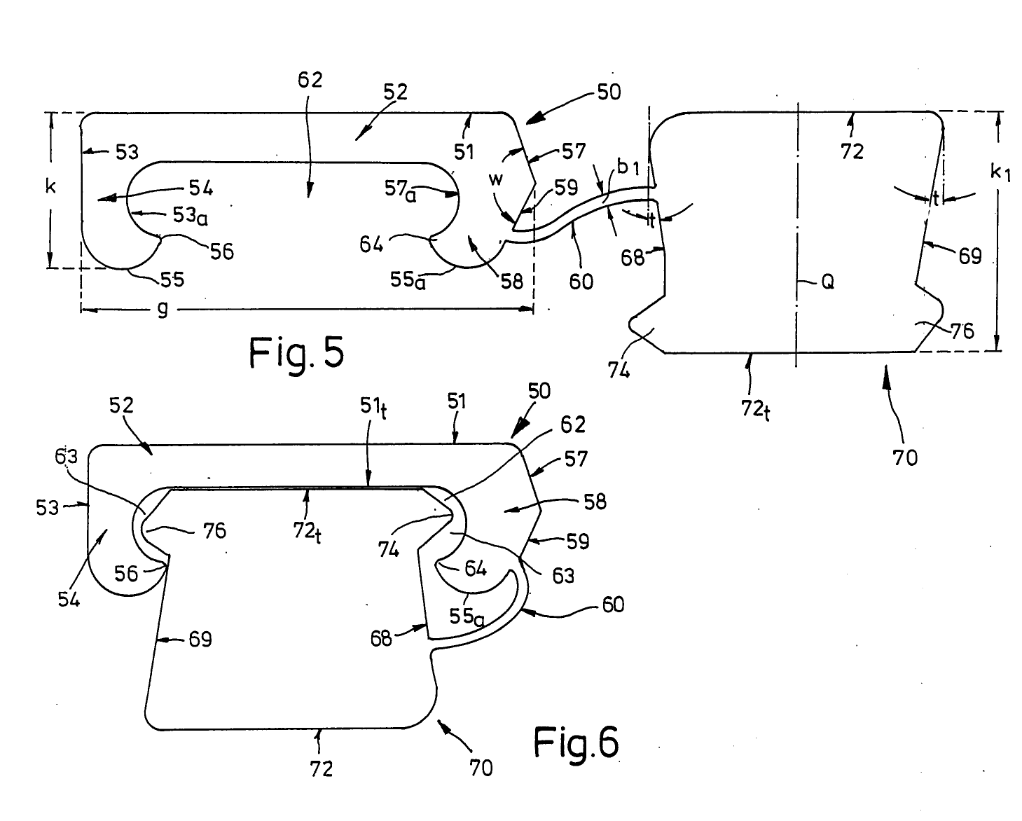

A channel profile 50 according to the invention which is formed from elastomer, caoutchouc or a rubber material of a Shore hardness according to DIN 53 505 of between 60 and 90 and has a width g of about 10 mm and the two channel legs 54, 58 of which, projecting from a base plate 52, have a free height k of about 3.5 mm is sketched in FIG. 5. The left-hand channel leg 54 therein forms a side face 53, at right angles to the base plate 52, of the channel profile 50 and has an inner contour 53ₐ which is in the shape of a circle segment and forms an inner rib 56 with an end region 55, likewise in the shape of a circle segment, of the channel leg 54. The other channel leg 58 adjoins said base surface 52 by means of an outer inclined surface 57 and likewise has, toward the channel space 62, an inner contour 57ₐ which is in the shape of a circle segment and which likewise merges into an inner rib 64. With the inner contours 53ₐ and 57ₐ in the shape of a circle segment, which respectively adjoin them, the inner ribs 56, 64 define an undercut region 63 of the channel space 62 (FIG. 6).

In cross section, the abovementioned inclined surface 57 adjoins, at one end, the outer surface 51 of said base plate 52 and, at the other end, an end inclined surface 59 which encloses with the outer inclined surface 57 an angle w of about 135° and merges into an end region 55ₐ in the shape of a circle segment.

At a distance from the channel profile 50, an insert profile 70 of virtually rectangular cross section is assigned to said channel profile 50 in FIG. 5 and is connected to it by a molded strip 60 of small thickness b₁; the latter is integrally formed on the one side on the end inclined surface 59 of the channel profile 50 and on the other side on a side face 68 of the insert profile 70 of height k₁. This side face 68, which starts from the ridge surface 72 of the insert profile 70, and the other side face 69 of the insert profile 70 run inward at an angle t of about 10° to the profile center line Q and merge into a respective side rib 74 or 76, respectively, of the insert profile 70. The one side rib 74 is formed by an approximately equilateral triangular cross section and the other side rib 76 is formed by a triangular cross section of non-equilateral shape. Both adjoin a base surface 72ₜ, parallel to the ridge surface 72, of the insert profile 70.

The above-described unit consisting of channel profile 50, molded strip 60 and insert profile 70 is jointly formed from the abovementioned material, for example by extrusion, and can then be installed according to FIG. 6. In this connection, it may be pointed out that the channel profile 50 is within the scope of the invention even without connection to the insert profile 70.

The insert profile 70 is fed to the channel space 62 of the channel profile 50 in such a way that the two side ribs 74, 76 come into the channel space 62 and engage behind the inner rib 56, 64 there, wherein the base surface 72ₜ of the insert profile 70 abuts against the inner surface 51ₜ of the base plate 52 of the channel profile 50.

1. Device for punching blanks from a planar part (10), comprising a punching blade (20) attached in a support plate (22) and projecting from the latter as a blade or cutting line, and profile strips which flank said punching blade (20), are made of a material that is flexible to a limited extent and are each inserted into a channel profile (50) in a positive-locking manner with a region of their cross section, wherein both the channel profile (50) and the profile strip, as insert profile (70), are formed from a material that is elastic to a limited extent.

2. Device according to claim 1, wherein the channel profile (50) and the insert profile (70) are jointly formed from the material that is elastic to a limited extent, with a molded strip (60) connecting the two.

3. Device according to claim 1, wherein the material is selected from the group consisting of elastomers, caoutchouc, and rubber material of 60 Shore to 90 Shore as molding material.

4. Device according to claim 1, wherein one channel leg (58) of the channel profile (50) has an inner rib (64) which projects toward the channel space (62) and from which an inner contour (57a), in the shape of a circle segment in cross section, of the channel space starts.

5. Device according to claim 4, wherein an inner rib (56) of the other channel leg (54) is opposite the inner rib (64) of the channel leg (58).

6. Device according to claim 4, wherein the two inner ribs (56, 64) each define a lateral undercut region (63) of the channel space (62).

7. Device according to claim 1, wherein the side faces (68, 69) of the insert profile (70) run at an angle (t) to the center line (Q) of the cross section and are provided at one end with a respective side rib (74, 76).

8. Device according claim 1, wherein the base surface (72t), assigned to the two side ribs (74, 76), of the insert profile (70) is assigned to the inner surface (51t) of the channel profile (50), with the molded strip (60) being bent.

9. Device according to claim 6, wherein the two side ribs (74, 76) of the insert profile (70) are arranged at a distance from the inner contour of the channel profile (50) fitted into said insert profile (70) (FIG. 6).

10. Device according to claim 2, wherein the unit consisting of channel profile (50), molded strip (60) and insert profile (70) is formed from the molding material by extrusion.

11. Device according to claim 2, wherein the molded strip (60) of small thickness (b₁) is integrally formed with its marginal regions on opposite side faces (59, 68) of the channel profile (50) and of the insert profile (70).

12. Device according to claim 2, wherein the side face of a channel leg (58) of the channel profile (50) which faces the molded strip (60) has two inclined surfaces (57, 59) running at an angle (w) to one another.

13. Device according to claim 12, wherein an angle (w) of about 130° to 140° is defined by both inclined surfaces (57, 59).

14. Device according to claim 12, wherein an angle (w) of about 135° is defined by both inclined surfaces (57, 59).

15. Device according to claim 12, wherein the molded strip (60) is integrally formed on the inclined surface (59) close to the free end (55a) of the channel leg (50).

16. Device according to claim 2, wherein the molded strip (60) is integrally formed on that side face (68) of the insert profile (70) which is adjacent to the channel profile (50).
